(19) United States
(12) Patent Application Publication
(10) Pub. No.: US 2014/0347805 A1
(43) Pub. Date: Nov. 27, 2014

(54) PORTABLE ELECTRONIC DEVICE

(71) Applicants: INVENTEC CORPORATION, Taipei (TW); Inventec (Pudong) Technology Corporation, Shanghai (CN)

(72) Inventor: Jhao-Ming WANG, Taipei (TW)

(73) Assignees: INVENTEC CORPORATION, Taipei (TW); Inventec (Pudong) Technology Corporation, Shanghai (CN)

(21) Appl. No.: 14/230,973

(22) Filed: Mar. 31, 2014

(30) Foreign Application Priority Data
May 21, 2013 (CN) 201310189951.3

(51) Int. Cl. G06F 1/16

(52) U.S. Cl. CPC G06F 1/1637
USPC 361/679.27

(57) ABSTRACT

A portable electronic device includes a first body, a second body and a third body. The first body includes a display module. The second body includes a first end and a second end, and the first body is pivoted on the first end. The third body, pivoted on the second end, includes an input module, a first surface and a second surface. The first surface and the second surface are opposite to each other, and the input module is exposed from the first surface. The portable electronic device has an opening status and a closing status. When the portable electronic device is at the closing status, the first body is stacked on the second body and the third body, and the display module faces the input module.

### CROSS-REFERENCE TO RELATED APPLICATIONS

This non-provisional application claims priority under 35 U.S.C. § 119(a) on Patent Application No(s). 201310189951.3 filed in China on May 21, 2013, the entire contents of which are hereby incorporated by reference.

### BACKGROUND OF THE INVENTION

1. Technical Field of the Invention

The disclosure relates to a portable electronic device, in particularly to a pivotal and portable electronic device.

2. Description of the Related Art

With the advances of technology, each kind of electronic devices are widely used in daily life. Take a laptop computer for example, users can carry the laptop to operate it at home, the office or in vehicles, even in the outdoors. Therefore, because of the convenience of the laptop computer, the laptop computer usually becomes a necessary electronic device for people.

However, during the use of the laptop computer, the user may not adjust the laptop computer to the most appropriate position for use because of the size and structural limitation, which does not meet the demand for an ergonomic design. In detail, when the laptop computer is disposed on a table, the distance between the user and the monitor is too short, and the viewing angle of the user is too large. Moreover, the keyboard is horizontally disposed on the table. Therefore, when the user operates the laptop computer for a long time, the wrist of the user may be sore, in prior art, a base having a slope surface is disposed on the table, and the laptop computer is disposed on the base. Thus, the viewing angle is decreased, but the problem that the distance between the user and the monitor is too small has not been solved. To sum up, the conventional laptop computer does not meet the ergonomic design, which makes the user feel uncomfortable when using the laptop computer.

### SUMMARY OF THE INVENTION

An embodiment of the disclosure provides a portable electronic device comprising a first body, a second body and a third body. The first body comprises a display module. The second body includes a first end and a second end, and the first body is pivoted on the first end. The third body, pivoted on the second end, comprises an input module, a first surface and a second surface. The first surface and the second surface are opposite to each other, and the input module is exposed from the first surface. The portable electronic device has an opening status and a closing status. When the portable electronic device is at the closing status, the first body is stacked on the second body and the third body, and the display module faces the input module.

### BRIEF DESCRIPTION OF THE DRAWINGS

The disclosure will become more fully understood from the detailed description given herein below for illustration only, thus does not limit the disclosure, wherein:

FIG. 1 is a schematic perspective view of a portable electronic device according to an embodiment of the disclosure;

FIG. 2 is a schematic exploded view of a portable electronic device according to an embodiment of the disclosure;

FIG. 3 is a schematic side view of a portable electronic device at a closing status according to an embodiment of the disclosure;

FIG. 4A is a schematic side view of a portable electronic device at a first opening mode according to an embodiment of the disclosure;

FIG. 4B is a schematic side view of a portable electronic device at a second opening mode according to an embodiment of the disclosure;

FIG. 4C is a schematic side view of a portable electronic device at a third opening mode according to an embodiment of the disclosure;

FIG. 5A is a schematic side view of a second body at a first position according to an embodiment of the disclosure;

FIG. 5B is a schematic side view of a second body at a second position according to an embodiment of the disclosure; and

FIG. 6 is a schematic perspective view of a portable electronic device according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Based on the above-mentioned problem, the disclosure provides a portable electronic device, which is a laptop computer, but not limited to the disclosure. The portable electronic device is disposed on a plane (e.g. a table) or on a user's leg to operate it, but the above-mentioned disposing positions are not limited to the disclosure. Moreover, the portable electronic device has a plurality of opening modes for using in different conditions.

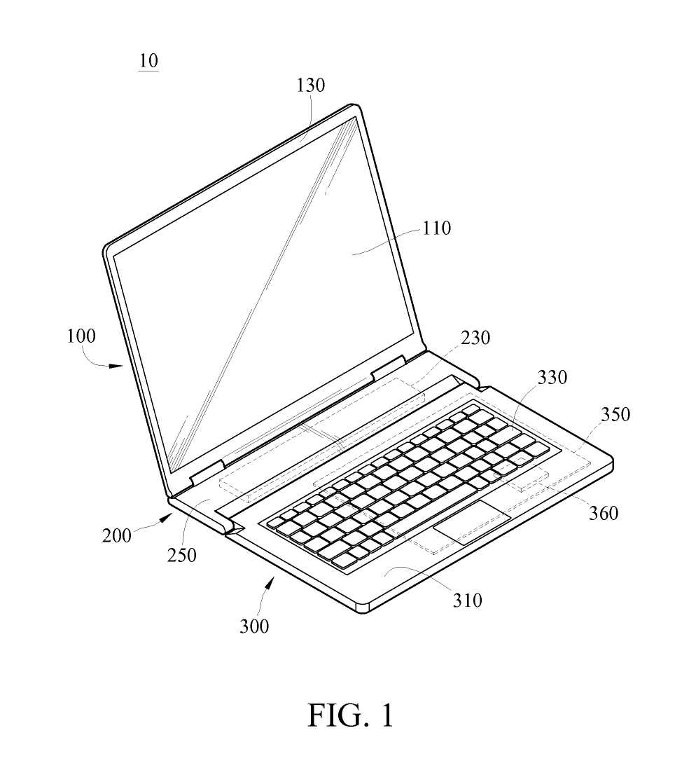

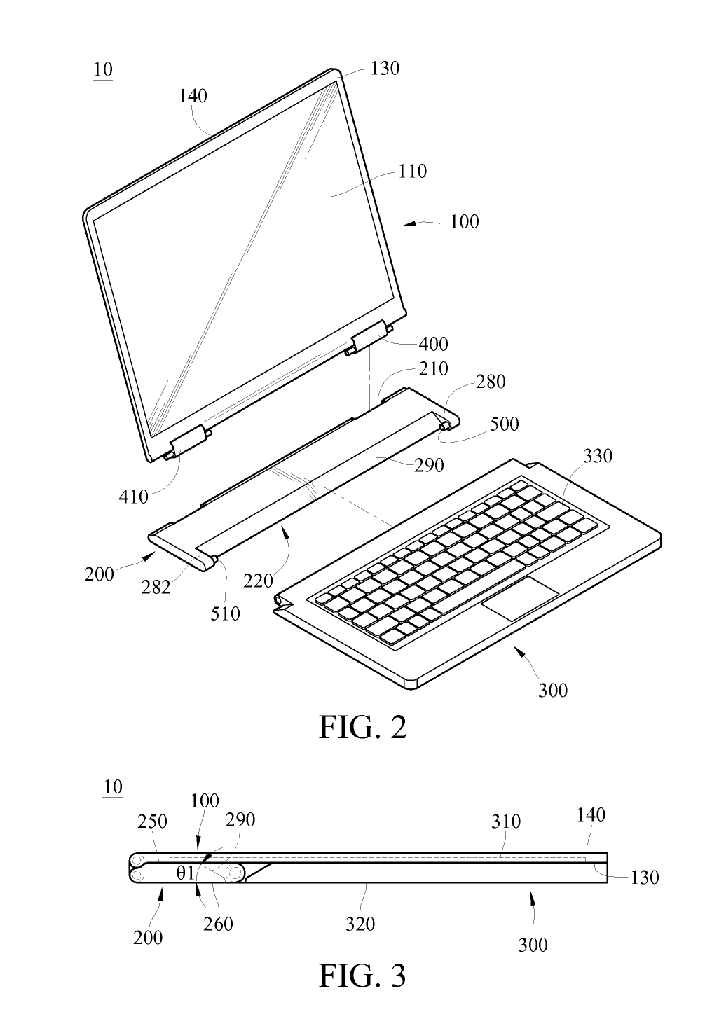

Please refer to FIGS. 1, 2 and 3. FIG. 1 is a schematic perspective view of a portable electronic device according to an embodiment of the disclosure, FIG. 2 is a schematic exploded view of a portable electronic device according to an embodiment of the disclosure, and FIG. 3 is a schematic side view of a portable electronic device at a closing status according to an embodiment of the disclosure.

A portable electronic device 10 comprises a first body 100, a second body 200 and a third body 300. The first body 100 comprises a display module 110. The second body 200 includes a first end 210 and a second end 220. The first body 100 is pivoted on the first end 210 of the second body 200. The third body 300, pivoted on the second end 220 of the second body 200, comprises an input module 330. Therefore, the first body 100 and the third body 300 are both adapted for pivoting on the second body 200.

In this and some other embodiments, the portable electronic device 10 further comprises two first connecting components 400 and 410 and two second connecting component 500 and 510. The first body 100 is connected to the first end 210 of the second body 200 via the first connecting components 400 and 410. The second end 220 of the second body 200 is connected to the third body 300 via the second connecting component 500 and 510. In this and some other embodiments, the first connecting components 400 and 410 and the second connecting components 500 and 510 are hinges, but the numbers and the types of the first connecting components and the second connecting components are not limited to the disclosure.

The following describes the structure of the third body 300 in detail. In this and some other embodiments, the third body 300 further includes a first surface 310 and a second surface 320 opposite to each other. The third body 300 comprises a mother board 350 and a central processing unit (CPU) 360. The input module 330 is exposed from the first surface 310 for a user to operate the input module 330. The input module 330 is a keyboard or a touch screen, but is not limited to the disclosure. The CPU 360 is disposed on and electrically connected to the mother board 350. The input module 330 is electrically connected to the mother board 350.

The following describes the structure of the first body 100 in detail. In this and some other embodiments, the first body 100 includes a third surface 130 and a fourth surface 140 opposite to each other. The display module 110 is disposed on the third surface 130.

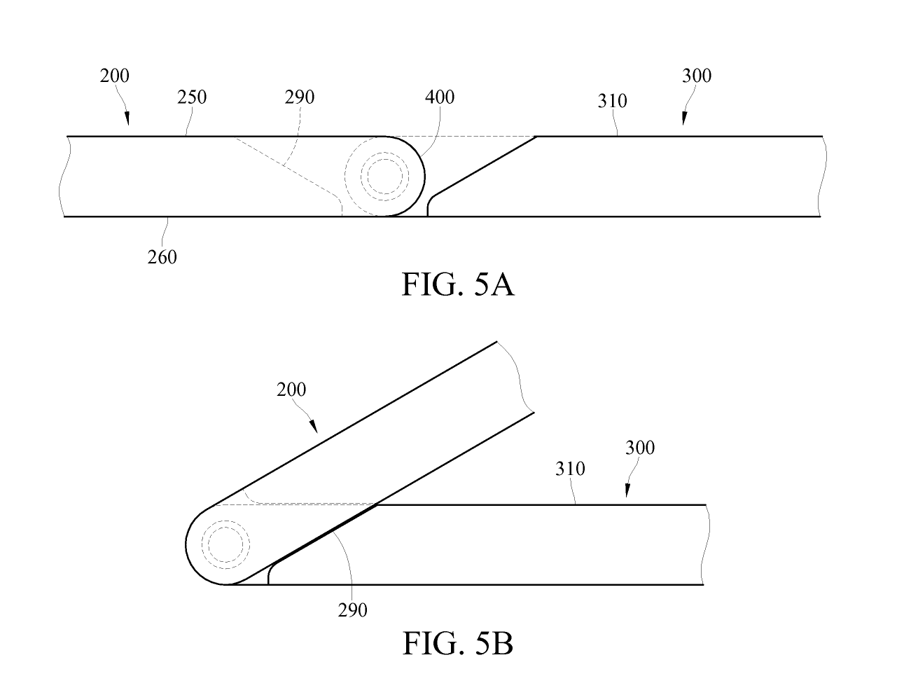

The following describes the structure of the second body 200 in detail. Please refer to FIGS. 1, 2 and 5A together. FIG. 5A is a schematic side view of a second body at a first position according to an embodiment of the disclosure. In this and some other embodiments, the first end 210 and the second end 220 are opposite to each other. The second body 200 comprises a power module 230, a plurality of data bus lines (not shown, namely, cables or wires) and a plurality of connecting ports (not shown). Furthermore, the second body 200 includes a fifth surface 250, a sixth surface 260, two protruding portions 280 and 282 and a slope 290. The fifth surface 250 and the sixth surface 260 are opposite to each other. The power module 230 is electrically connected to the mother board 350. The protruding portion 280 and 282 and the slope 290 are respectively disposed on the second end 220. The slope 290 is located between the protruding portions 280 and 282, and an angle θ1, formed between the slope 290 and the sixth surface 260, is less than 90 degrees. Moreover, some of the data bus lines of the second body 200 pass through the first connecting components 400 and 410 so as to be electrically connected to the display module 110 of the first body 100. Some other data bus lines of the second body 200 pass through the second connecting components 500 and 510 from the protruding portions 280 and 282 so as to be electrically connected to the mother board 350 of the third body 300. Therefore, the display module 110 of the first body 100 and the power module 230 of the second body 200 are electrically connected to the mother board 350 of the third body 300, respectively. Furthermore, the connecting ports are exposed to the outside so as to be electrically connected to other peripherals (not shown).

The following describes different operating statuses of the portable electronic device 10. Please refer to FIG. 3, which is a schematic side view of a portable electronic device at a closing status according to an embodiment of the disclosure. In this and some other embodiments, the portable electronic device 10 has a closing status. When the portable electronic device 10 is at the closing status, the first body 100 is stacked on the second body 200 and the third body 300, and the display module 110 faces the input module 330. In detail, the fourth surface 140 of the first body 100, the sixth surface 260 of the second body 200, the second surface 320 of the third body 300 are exposed to the outside of the portable electronic device 10. Therefore, the sixth surface 260 and the second surface 320 are in contact with the same plane (not shown), such that the portable electronic device 10 is disposed on the plane to be operated by the user. Furthermore, the third surface 130 of the first body 100 faces the fifth surface 250 of the second body 200 and the first surface 310 of the third body 300 at the same time. In other words, the display module 110 and the input module 330 are not directly exposed to the outside. Thus, when being in the closing status, the portable electronic device 10 is adapted for storage and carrying.

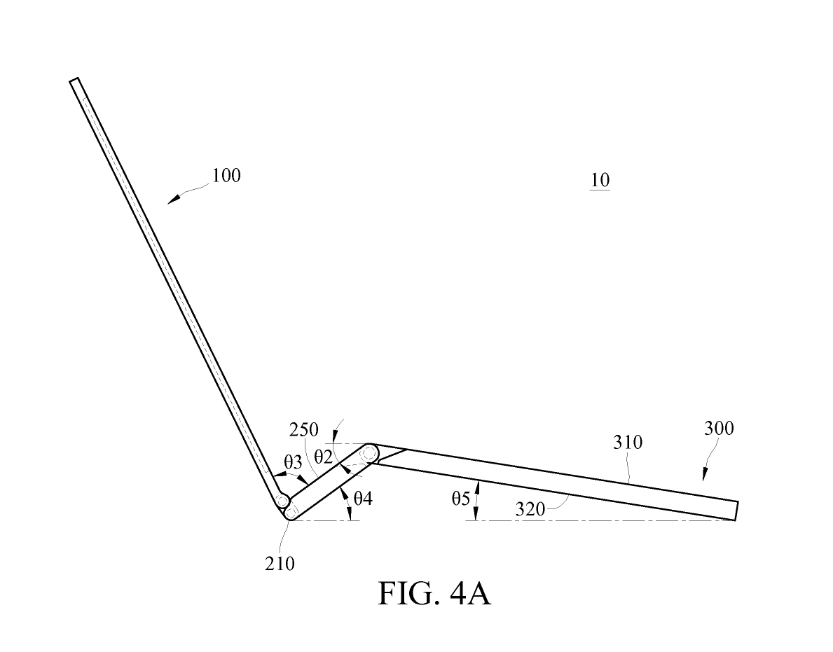

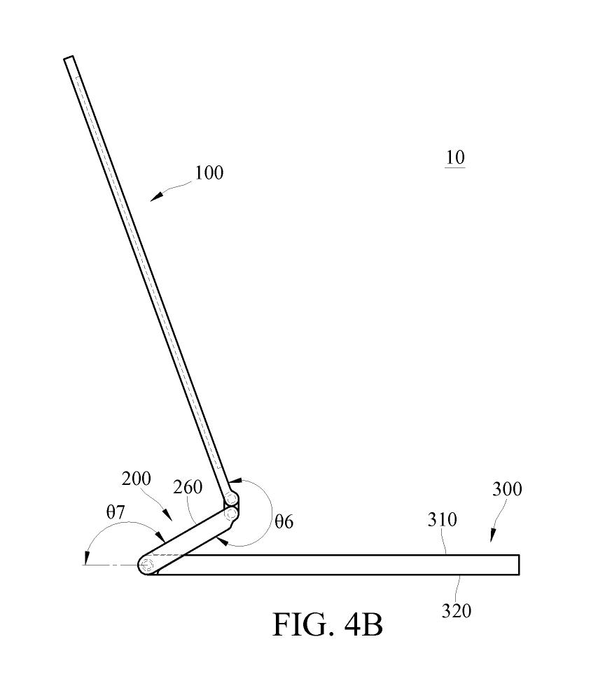

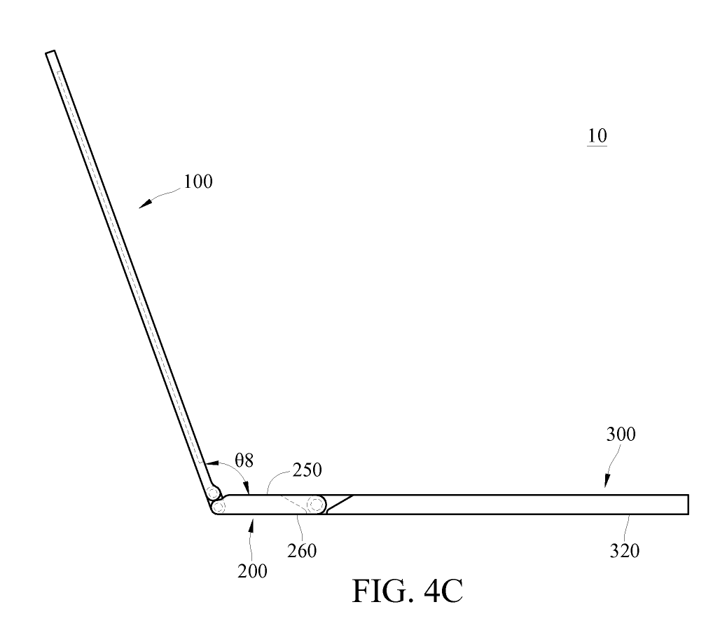

Please refer to FIGS. 4A, 4B and 4C together. FIG. 4A is a schematic side view of a portable electronic device at a first opening mode according to an embodiment of the disclosure, FIG. 4B is a schematic side view of a portable electronic device at a second opening mode according to an embodiment of the disclosure, and FIG. 4C is a schematic side view of a portable electronic device at a third opening mode according to an embodiment of the disclosure. In this and some other embodiments, the portable electronic device 10 has an opening status, and the opening status has a first opening mode (as shown in 4A), a second opening mode (as shown in FIG. 4B) and a third opening mode (as shown in 4C).

The following describes the three opening modes in order. In this and some other embodiments, when the portable electronic device 10 is moved from the closing status (as shown in FIG. 3) to the first opening mode (as shown in FIG. 4A), the second body 200 is pivoted towards the second surface 320 of the third body 300, and the first body 100 is pivoted away from the fifth surface 250 of the second body 200. In detail, in one embodiment, the second body 200 is pivoted towards the second surface 320 of the third body 300 at an angle θ2 less than 90 degrees, and the first body 100 is pivoted away from the fifth surface 250 of the second body 200 at an angle θ3 equaled to or less than 90 degrees. Therefore, as shown in FIG. 4A, the portable electronic device 10 forms a saw-tooth shape opening status. When the first end 210 of the second body 200 and an edge of the third body 300 are both disposed on a plane, the second body 200 and the third body 300 form angles θ4 and θ5 with respect to the plane, respectively, so as to meet the ergonomic design, thereby being beneficial for the user to operate. However, the above-mentioned rotating angles and disposing positions are not limited to the disclosure. In other embodiments, the second surface 320 of the portable electronic device 10 is in contact with the legs of the user, such that the positions of the portable electronic device 10 may be adjusted according to user requirement.

In this and some other embodiments, when the portable electronic device 10 is moved from the closing status to the second opening mode (as shown in FIG. 4B), the first body 100 is pivoted toward the sixth surface 260 of the second body 200, and the second body 200 is pivoted toward the first surface 310 of the third body 300. In detail, according to one embodiment, the first body 100 is pivoted towards the sixth surface 260 of the second body 200 at an angle θ6 larger than 90 degrees. Moreover, the second body 200 is pivoted towards the first surface 310 of the third body 300 at an angle θ7 larger than 90 degrees. When the second surface 320 of the third body 300 is disposed on a plane, compared to the first opening mode, the height of the first body 100 is greater at the second opening mode. Therefore, the viewing angle of the user is reduced, so as to meet the ergonomic design. However, the above-mentioned rotating angle is not limited to the disclosure,

In this and some other embodiments, when the portable electronic device 10 is moved from the closing status to the third opening mode (as shown in FIG. 4C), the first body 100 is pivoted away from the fifth surface 250 of the second body 200 at an angle θ8 equaled to or less than 180 degrees. Therefore, the sixth surface 260 of the second body 200 and the second surface 320 of the third body 300 are disposed on a plane for the user to operate. In some other embodiments, the first body 100 is pivoted away from the fifth surface 250 of the second body 200 at an angle θ8 from 180 to 360 degrees for more modes.

The following describes the limitation of the slope 290 of the second body 200. Please refer to FIGS. 5A and 5B. FIG. 5B is a schematic side view of a second body at a second position according to an embodiment of the disclosure. In this and some other embodiments, the second body 200 has a first position (as shown in FIG. 5A) and a second position (as shown in FIG. 5B) with respect to the third body 300. When the portable electronic device 10 is at a closing status or a third opening mode, the second body 200 is at the first position as well as the slope 290 and the third body 300 are separated from each other. When the second body 200 is moved from the first position to the second position, the portable electronic device 10 is at the second opening mode, and the slope 290 limits the first surface 310 of the third body 300. Therefore, the position of the second body 200 is limited at the second position by the slope 290.

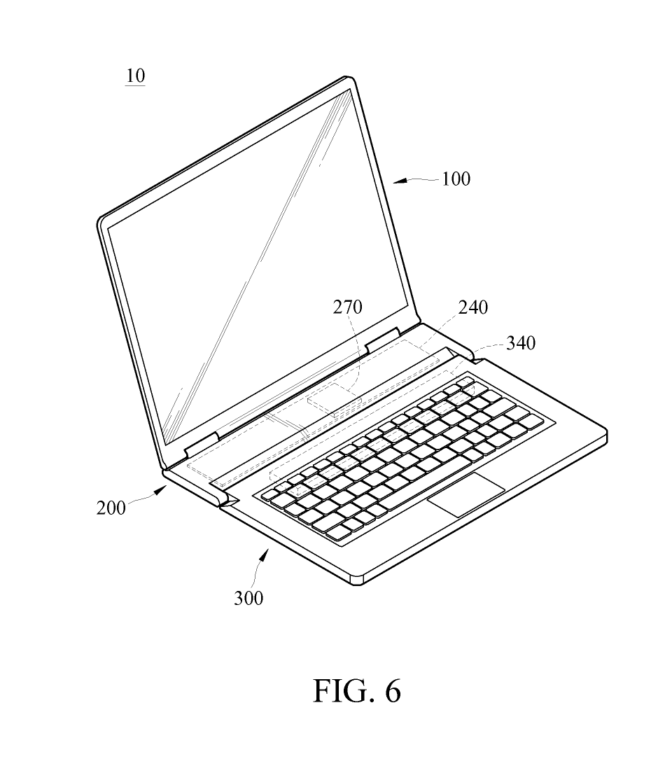

However, the above-mentioned disposing positions of the mother board, the CPU and the power module are not limited to the disclosure. Please refer to FIG. 6, which is a schematic perspective view of a portable electronic device according to another embodiment of the disclosure. The structure of the portable electronic device in this embodiment is similar to that in the above-mentioned embodiment, therefore the same numerals represent the similar structure, and the repeated structures are not described again. In other embodiments, a mother board 240 and a CPU 270 is disposed in the second body 200. A power module 340 is disposed in the third body 300.

To sum up, in the portable electronic device according to the embodiment, the first body is pivoted on the second body and the second body is pivoted on the third body, such that the user may freely adjust the disposition and the position of the portable electronic device, so as to meet the ergonomic design. Moreover, the portable electronic device may be adjusted according to the current posture of the user, thereby solving the problem that the conventional laptop computer may cause the user to feel uncomfortable.

What is claimed is:

1. A portable electronic device, comprising:
a first body comprising a display module;
a second body including a first end and a second end, and the first body is pivoted on the first end; and
a third body pivoted on the second end, the third body comprising an input module, and a first surface and a second surface opposite to each other, and the input module being exposed from the first surface;
wherein the portable electronic device has an opening status and a closing status, when the portable electronic device is at the closing status, the first body is stacked on the second body and the third body, and the display module faces the input module.

2. The portable electronic device according to claim 1, further comprising at least one first connecting component, and wherein the first body is connected to the first end of the second body via the at least one first connecting component.

3. The portable electronic device according to claim 1, further comprising at least one second connecting component, and wherein the second end of the second body is connected to the third body via the at least one second connecting component.

4. The portable electronic device according claim 3, wherein the at least one second connecting component is a hinge.

5. The portable electronic device according to claim 1, wherein the second end of the second body includes a slope, the second body includes a first position and a second position with respect to the third body, when the second body is at the first position, the slope is separated from the third body, and when the second body is pivoted from the first position to the second position, the slope is limited to the first surface of the third body.

6. The portable electronic device according to claim 1, wherein the opening status has a first opening mode and a second opening mode, when the portable electronic device is moved from the closing status to the first opening mode, the second body is pivoted towards the second surface of the third body, and when the portable electronic device is moved from the closing status to the second opening mode, the second body is pivoted towards the first surface of the third body.

7. The portable electronic device according to claim 1, wherein the second body comprises a power module, the third body comprises a mother board and a central processing unit (CPU), and the CPU is disposed on the mother board.

8. The portable electronic device according to claim 1, wherein the second body comprises a mother board and a CPU, the CPU is disposed on the mother board, and the third body comprises a power module.

9. The portable electronic device according to claim 1, wherein the first end and the second end are opposite to each other.
